(19) United States
(12) Patent Application Publication
(10) Pub. No.: US 2003/0082456 A1
(43) Pub. Date: May 1, 2003

(54) Mercury-free alkaline button cell

(76) Inventor: Wing Kei Ho, Kwun Tong (HK)

Correspondence Address: LEYDIG VOIT & MAYER, LTD, 700 THIRTEENTH ST. NW, SUITE 300, WASHINGTON, DC, 20005-3960, US

(21) Appl. No.: 10/189,521

(22) Filed: Jul. 8, 2002

(30) Foreign Application Priority Data
Oct. 19, 2001 (CN) 01234722.1

(51) Int. Cl. H01M 4/66; H01M 2/08; H01M 4/42; H01M 4/50; H01M 4/54

(52) U.S. Cl. 429/245; 429/174; 429/229; 429/224; 429/219

(57) ABSTRACT

A mercury-free alkaline button cell battery, includes an anode plate, a cathode cap, a cathode zinc paste, a seal ring, an anode case and a membrane. A layer of indium or tin is plated on the cathode plate, and indium is added into the zinc paste to replace mercury. A layer of indium or tin is plated on the cathode plate to prevent zinc in the cell from contacting other material or metal, to avoid swelling that could result in the release of gas.

### FIELD OF INVENTION

The present invention relates to mercury-free alkaline button cell batteries. More particularly, although not exclusively, the invention relates to zinc/manganese and zinc/silver manganese mercury-free alkaline button cell batteries.

### BACKGROUNDS OF INVENTION

Known button cell batteries contain zinc. Mercury is added to prevent the zinc from contacting other material (particularly metals), to thereby curtail swelling that would result from gas-release.

With regard to protection of the environment, however, power core cells without mercury have gradually been adopted. Swelling resulting from gas-release can be ignored for AA and AAA cells, since their dimensions are large and there is sufficient space to accept the gas. However, the dimension of power core button cell batteries are relative small, and there is no additional space for receiving the released gas. Accordingly, mercury must be added in a button cell battery to prevent zinc from contacting other material or metal, so as to prevent profile distortion resulting from released gas. Therefore, there is a strong demand for a mercury-free button cell battery that is environmentally friendly.

### OBJECT AND SUMMARY OF THE INVENTION

The object of the present invention is to provide a zinc/manganese and/or zinc/silver manganese mercury-free alkaline button cell battery.

There is disclosed herein a mercury-free button cell battery, comprising:

an anode case,

an anode plate situated within the anode case,

a cathode cap fitted to the anode case,

a sealing ring sealing the cathode cap to the anode case,

zinc-containing paste situated within the anode case between the anode plate and the cathode cap,

a membrane between the anode plate and the zinc paste, the battery being characterized in that:

a layer of indium or tin is plated on the cathode plate, and indium is included in the zinc paste.

Preferably the cathode cap is made of iron or stainless steel plate.

Preferably the anode plate is a manganese plate

Preferably the anode plate is a silver oxide plate or a composite plate of silver oxide and manganese oxide.

There is further disclosed herein a button cell battery comprising, a cathode plate having a layer of indium or tin.

This can prevent contact between zinc and cathode plate due to gas swelling, so it is not necessary to add mercury to prevent swelling and the demand for environment protection is achieved.

Preferably, the cathode plate is made of metal, then nickel or copper is plated onto it, followed by plating a layer of indium or tin.

Preferably the cathode plate is made of iron or stainless steel.

Preferably the method includes plating a layer of nickel or copper on the cathode plate, then plating a layer of indium or tin thereon.

Alternatively, the method includes plating a layer of nickel or copper on a coiled metal plate, followed by plating a layer of indium or tin thereon.

Indium or tin can be plated on one surface of the metal plate, Then it can be processed to make a cathode plate.

Preferably the surface that is plated with indium or tin contacts with a cathode zinc paste.

In accordance with the conventional methods for producing button cells, zinc/manganese mercury-free alkaline button cells can be produced by integration of the cathode plate with available cathode zinc paste, a seal ring, an anode case, a membrane and an anode manganese plate.

Advantages are:

The cathode zinc paste is readily attainable and can for example be the one sold by Shanghai Bai Luo Da Metal Co., Ltd, Shanghai, China. Its composition is as follows;

| | | Usage Range | |
|---|---|---|---|
| Element | Specification | (ppm) | Content (ppm) |
| Fe | <3 ppm | | 0.9 |
| Pb | 500 ppm | 450-550 | 483 |
| In | 500 ppm | 400-600 | 494 |
| Al | 100 ppm | 70-130 | 98 |

In another embodiment, zinc/silver manganese mercury-free alkaline button cells can be produced with silver oxide plate or silver and manganese composite oxide plate instead of the above-mentioned manganese plate.

Cathode zinc pastes in all of the commercially available zinc/manganese and zinc/silver manganese alkaline button cells contain mercury. According to the present invention, however, mercury is successfully replaced by adding indium into the zinc paste and by plating a layer of indium or tin on the cathode plate. Compared with the prior art, the advantage of the zinc/manganese and zinc/silver manganese alkaline button cells is that it is free of mercury. It does not pollute the environment with mercury during the production of cells, which meets demands for environment protection.

### DESCRIPTION OF THE DRAWINGS

A preferred form of the present invention will now be described by way of example with reference to the accompanying drawings, wherein:

FIG. 1 is a schematic sectional view of a zinc/manganese and zinc/silver manganese mercury-free alkaline button cell battery;

FIG. 2 is a schematic sectional view of the cathode cap of a zinc/manganese and zinc/silver manganese mercury-free alkaline button cell battery;

FIG. 3 shows the estimated average service time of a AG10 button cell, wherein the cell system is zinc/manganese dioxide, and is evaluated under a load of 10000 Ω at 21° C. within 30 days after production; and

FIG. 4 shows the estimated average service time of a AG3/LR41 button cell, wherein the cell system is zinc/manganese dioxide, and is evaluated under a load of 15000 Ω at 21° C. within 30 days after production.

### DESCRIPTION OF THE PREFERRED EMBODIMENTS

### EXAMPLE 1

According to the conventional methods, a cathode plate made of metal was plated with a layer of nickel or copper, then it was plated with a layer of indium by a roll-plating method. The procedures of the method of roll-plating indium was as follows:

A cathode plate plated with a layer of nickel or copper was placed on a roller in indium sulphate plating solution with a pH value of 3. Then a potential difference of 7 volts was applied. After 60 minutes of roll-plating, the cathode plate was taken out and flushed with water immediately. After putting it into a dryer to dry with hot air, a cathode plate used to produce zinc/manganese and zinc/silver manganese mercury-free alkaline button cells wag prepared.

In accordance with the conventional methods for producing button cells, zinc/manganese mercury-free alkaline button cells with an indium-plated cathode plate can be produced by integration of the cathode plate obtained above with the commercially available cathode zinc paste, seal ring, anode case, membrane and anode manganese plate.

### EXAMPLE 2

The same procedures of EXAMPLE 1 were repeated to produce a zinc/manganese mercury-free alkaline button cells with a tin-plated cathode plate, except that the indium was replaced by tin.

### EXAMPLE 3

The same procedures of EXAMPLE 2 were repeated to produce a zinc/manganese mercury-free alkaline button cells with tin-plated cathode plate, except that the manganese plate was replaced by a plate of silver oxide or a composite plate of silver oxide and manganese oxide.

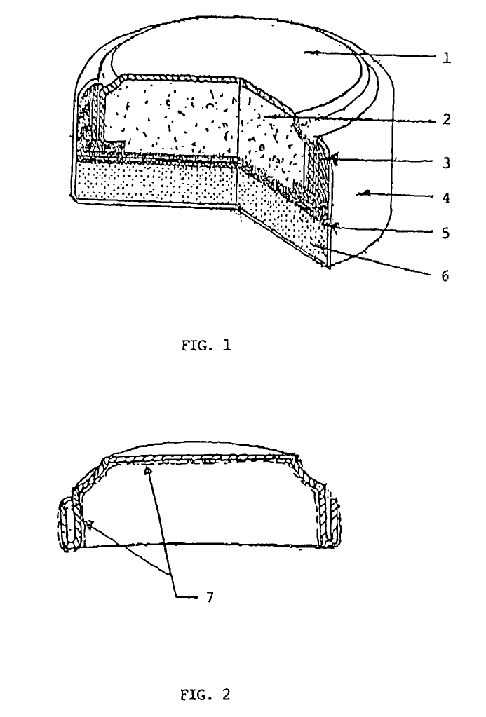

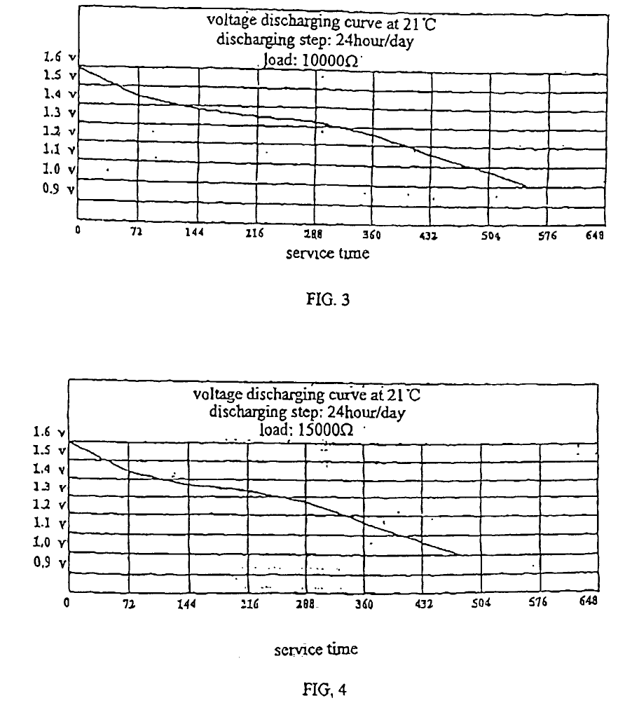

As shown in FIG. 1, zinc powder is wrapped in the power core cell and directly contacts the cathode plate, on which indium or tin is plated.

Test results are shown in Table 1.

TABLE 1

| | Results (%) | | |
|---|---|---|---|
| | AG10 button | AG13 button | 98/101/EEC |
| Testing items | cell | cell | Specification (%) |
| Mercury content | 0.0004 | 0.0003 | <2 |
| Cadmium content | <0.002 | <0.002 | <0.025 |
| Lead content | 0.01 | <0.01 | <0.4 |

As can be seen from Table 1, all the mercury content, the cadmium content and the lead content of AG10 and AG13 button cells are lower than the allowed maximum value as prescribed in the Button Cell Standard 98/101/EEC.

The test results of AG3 alkaline button cells obtained by an induction couple plasma spectrometer—mass spectrometer are shown in Table 2.

TABLE 2

| Testing parameter | Results (mg/kg) (ppm) |
|---|---|
| Lead content | *32 |
| Cadmium content | <0.05 |
| Mercury content | *0.269 |

Testing limit = 0.1 mg/kg
*average value of two testing results

The above test results show that the mercury content in the button cells is only at a level of 0.26 mg/kg(ppm), which meets the environment protection standards and can be marketed as “mercury-free” cells.

In FIG. 1, there is schematically depicted in cut-away form, a button cell comprising a cathode cap 1, a cathode zinc paste 2, a seal ring 3, and an anode case 4, a membrane 5 and an anode manganese plate 6. FIG. 2 shows a layer of indium 10 plated onto the cathode.

1. A mercury-free button cell battery, comprising:
an anode case,
an anode plate situated within the anode case,
a cathode cap fitted to the anode case,
a sealing ring sealing the cathode cap to the anode case,
zinc-containing paste including indium, situated within the anode case between the anode plate and the cathode cap,
a membrane between the anode plate and the zinc paste, and
a layer of indium or tin plated on the cathode plate.

2. The button cell of claim 1, wherein the cathode cap is made of iron or stainless steel plate.

3. The button cell of claim 1 or claim 2, wherein the anode plate is a manganese plate.

4. The button cell of claim 1 or claim 2, wherein the anode plate is a silver oxide plate or a composite plate of silver oxide and manganese oxide.

5. A button cell battery comprising, a cathode plate having a layer of indium or tin.

6. A method of manufacturing the battery of claim 5, wherein the cathode plate is made of metal, then nickel or copper is plated onto it, followed by plating a layer of indium or tin thereon.

7. The method of claim 6, wherein the cathode plate is made of iron or stainless steel.

8. The method of claim 7, further including plating a layer of nickel or copper on the cathode plate, then plating a layer of indium or tin thereon.

9. The method of claim 7, further including plating a layer of nickel or copper on a coiled metal plate, followed by plating a layer of indium or tin thereon.

10. The method of claim 9, wherein tin is plated on one surface of the metal plate.

11. The method of claim 10, wherein the surface that is plated with indium or tin contacts with a cathode zinc paste in the finished battery.
